(19) United States
(12) Patent Application Publication
(10) Pub. No.: US 2010/0212700 A1
(43) Pub. Date: Aug. 26, 2010

(54) DISHWASHER DETERGENT DISPENSING MODULE

(75) Inventors: Mark Douglas Wattley, Louisville, KY (US); Erin Whitney Gnadinger, Louisville, KY (US); James Christopher Roberts, Louisville, KY (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/393,649

(22) Filed: Feb. 26, 2009

(51) Int. Cl. B08B 3/00

(52) U.S. Cl. 134/93; 68/17 R

(57) ABSTRACT

A dishwasher detergent module for detergent includes a dispenser body having at least two individual, isolated compartments that prevent intermix of contents and corresponding latch covers that close over the compartments. Each of the compartments automatically time-release detergents, during different stages of a wash cycle so that an entire concentration is not diluted as a single release in one cycle segment. A press of a push-button simultaneously and manually releases catch locks for all covers before a wash cycle, but the covers open in sequence when they are automatically released during the cycle. The dispenser module further includes an actuator to command the covers to open separately in the wash cycle in a time sequence.

### BACKGROUND OF THE DISCLOSURE

The present disclosure relates generally to an improved, sequence-activated detergent dispenser for dishwashers and, more specifically, to a multiple-compartment dispenser that releases partial amounts of detergent(s) during different stages of an operating cycle.

Conventional dishwashers circulate a solution of water and detergent throughout a chamber to remove food soils and to sanitize dishes. These dishwashers comprise detergent dispensers on door assemblies; namely, a refillable compartment accessed by means of a removably attachable cover. Detergent is routinely placed therein before the wash cycle is executed. A spray jet then directs water at the compartment when a timer releases its cover. A disadvantage realized in conventional systems is that it limits detergent release to one cycle segment, i.e., to the main wash; however, recent studies suggest that greater time exposure to increased detergent concentrations yields improved wash scores.

There is more recent interest in increasing an efficiency of wash cycles based on proper amounts and time-release of detergents. It is discovered that too little detergent fails to remove stuck-on matter and too much detergent leaves dishes etched or spotted. A bulk-dispense detergent module has been developed to receive an entire bottle of liquid gel detergent so that an operator doesn't have to make repeat fills to the conventional compartment between wash cycles. A primary advantage of this module is that it pumps variable amounts of liquid detergent during at least one portion of a wash cycle. The amount is dependent on sensor readings during individual washes, s.a., e.g., water temperature, water hardness, and soil level, etc.

The bulk dispense module relies on a pump mechanism to deliver the gel; hence, it cannot utilize powder or tablet-type detergents. The bulk system cannot reliably handle powder detergents because the high moisture content of dishwashers causes granules to clump together and clog up the delivery conduit. A tank housing a bottle of detergent for bulk-dispense modules is only efficient for persons who very frequently run dishwashers.

A further disadvantage is that liquid detergents' effectiveness deteriorates over time. For example, gel detergents have shorter shelf lives; their ingredients separate; and, they must remain suspended for effective cleaning. Powdered detergent more strongly impacts wash performance verses its liquid and gel counterparts. Accordingly, there exists a need for a dishwasher capable of sequentially delivering variable quantities of powdered detergent during multiple wash and rinse periods.

### SUMMARY OF THE DISCLOSURE

The present disclosure is a dishwasher detergent module for detergents including a dispenser body having at least two individual, isolated compartments that prevent intermix of their respective contents and corresponding latch covers that close over each of the compartments. Each compartment is assigned to a one of a stage of pre-wash, main wash, and rinse cycles. The compartments automatically time-release detergents during different stages of a wash cycle so that an entire detergent concentration is not diluted as a single release in one cycle segment. The compartments vary in size such that different volumes of detergent are dispensed at the different stages.

One aspect of the present invention is that it enables an operator to utilize multiple detergent types in a single wash cycle. Liquid gel and powdered detergent types would inactivate if mixed in the past, but each of the compartments can separately contain a different, automatic detergent type from a next compartment. Walls extend above a height of the compartments' opposing sidewalls to further partition each compartment from adjacent ones. Hinges that extend a length between distal ends of the walls pivotally support the compartment's respective cover.

Each of the covers opens and closes by means of its own catch-and-release lock. A press of a push-button on the dispenser body simultaneously releases the catches for all covers such that they open in unison when they are manually released; however, the covers open in sequence when they are automatically released.

A means to command the covers to open separately in a time release may include a paraffin wax or a solenoid actuator that automatically opens compartments in sequence each instance the actuator responds to changes in a chamber environment. One or a plurality of timers may alternatively execute release commands each instance a timer goes off. The timer(s) is in direct communicative relationship to a central circuit that commands release of the corresponding covers. Sensors can similarly activate the covers to release when certain parameters are met, for example, when the washing fluid drains, and, when the chamber temperature changes, etc. The foregoing actuators, timer, and sensors can also be utilized in combination.

A method to utilize a multi-compartment dispenser, containing the foregoing features, includes at least two automatic steps selected from a group including time-releasing a cover on a first compartment during a pre-wash cycle; time-releasing a cover on a second compartment at an initiation of a main wash cycle; time-releasing a cover on a third compartment to introduce additional detergent after a preset time has passed in the main wash cycle; and, time-releasing a cover on a fourth compartment to introduce a sanitizing or rinsing agent at an initiation of a rinse cycle.

### BRIEF DESCRIPTION OF THE DRAWINGS

FIG. 1 is a dishwasher detergent module shown on a door assembly according to the present disclosure;

FIG. 2 is a top-elevational view of a dispenser embodiment;

FIG. 3 is a top-elevational view of the dispenser shown in FIG. 2, wherein individual latch covers close over corresponding compartments;

FIG. 4 is a graph recording the effectiveness of powder detergents over a typical wash cycle utilizing systems;

FIG. 5 is a graph recording the effectiveness of powder detergents over a typical wash cycle utilizing the dispenser module presently disclosed; and,

FIG. 6 is a schematic mapping of one method embodiment utilizing the dispenser module taught herein.

### DETAILED DESCRIPTION OF THE PREFERRED EMBODIMENTS

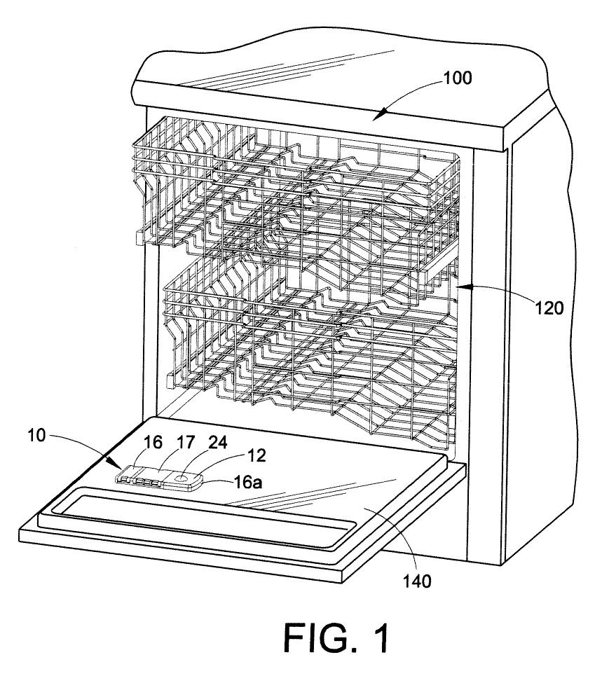

The present disclosure is directed to a dishwasher detergent dispensing module 10 (hereinafter synonymously referred to as “dispenser”, “detergent dispenser”, “dispenser module” and “multi-compartment dispenser”). It is also to be understood that “detergent” as used herein is intended to broadly include detergents, rinse aid additives, sanitizing additives, and any other types of additives that might be used in the wash or rinse cycles of an automatic dishwashing appliance, and which may be in powder, liquid, gel or capsule form. FIG. 1 shows a partial view of a dishwasher 100 with a front door 140 in an opened position. The dishwasher 100 includes at least one rack 120 which supports soiled dishes. The dispenser module 10 is shown positioned on an inside surface of a chamber door 140. However, its placement is neither limited to the inside door panel nor to any specific location on that panel. Placement of the dispenser 10 is most dependent upon the washing fluid's ability to positively contact the detergent it releases.

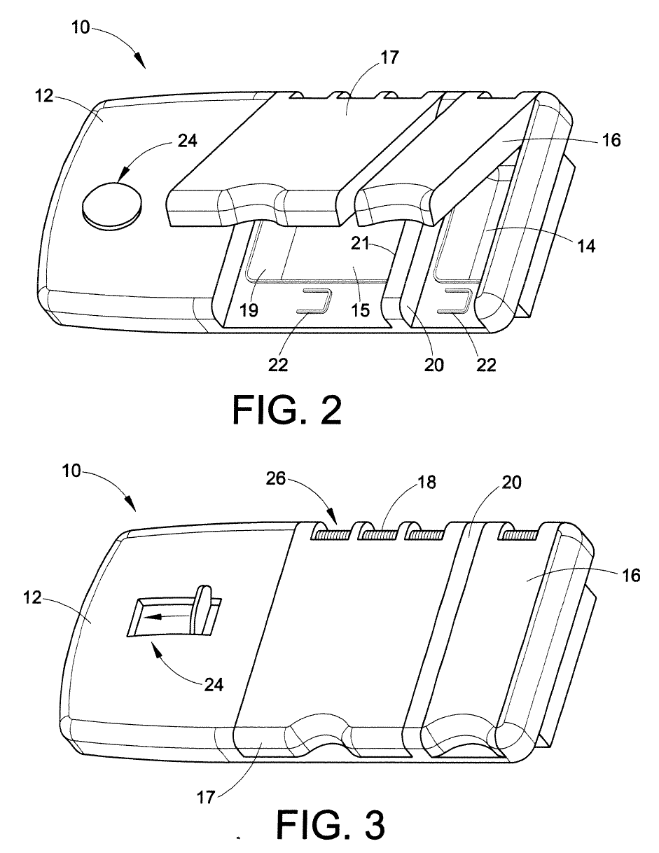

FIG. 2 is a top-elevational view of a first embodiment of the dispenser 10. The dispenser 10 includes a body 12 having a plurality of individual, isolated compartments 14, 15 that prevent intermix of their respective contents. The dispenser 10 is shown in FIG. 2 to include two compartments, but embodiments having at least three or more compartments are also contemplated. Existing dishwashers include two dispenser sections: a first, pre-rinse compartment that empties detergent into the dishwasher when the door closes; and, a second compartment that automatically empties detergent into the dishwasher during the main wash. These compartments are not necessarily formed on the same body since the former compartment is open while the latter existing compartment is covered; however, if the two are neighboring or adjoining, a removable cover only extends a length to seal the main wash compartment since one automatic detergent release is limited to the main wash cycle.

In the dispenser module 10, each of its compartments 14, 15 is covered; hence, automatic detergent releases are possible during multiple cycle segments. A typical dishwasher can circulate water seven or more times during a wash cycle. As used herein, the term “wash cycle” refers to the overall operating cycle of the dishwasher, which typically includes a plurality of pre-wash, wash, and rinse cycles. For example, a typical wash cycle includes at least two pre-rinse cycles that first rinse soil off dishes. A main wash next releases detergent to aid in removing stuck-on grease and other matter. Multiple rinses then ensure that remaining soil is removed, that detergent is rinsed off, and that dishes are sanitized. Various compartments 14, 15 of this dispenser module 10 can automatically time-release detergents and rinse agents during different stages of the wash cycle. Each compartment 14, 15 is assigned to a different stage. It should be noted that particular cycles of a wash cycle, for example the main wash cycle, may comprise multiple stages, so detergent in a first compartment 14 releases at a beginning of the main wash, and then a second compartment 15 releases detergent a certain number of minutes, e.g., ten minutes, into the main wash cycle.

Each of the separate compartments 14, 15 is closed by means of a corresponding lid or cover 16, 17. The covers 16, 17 are preferably, but not limited to, latch covers that hingedly open-and-close over their respective compartments 14, 15. It is anticipated that cover doors 16, 17 remain affixed to the dispenser body 12 by means of hinges 18 that extend a length of the compartments 14, 15 they cover. A wall 20 extends above a height of each compartment's opposing sidewalls 19, 21 to further partition one compartment from an adjacent one. The hinges 18 more suitably travel between the distal ends of walls 20 so that the closed cover 16, 17 does not compete with detergent space in the compartment 14, 15; hence, the cover won't jam from overflow of detergent.

Each compartment cover 16, 17 is individually closable and latchable by means of a manually actuable catch-lock mechanism. The catch-lock mechanism is also operative to simultaneously release each of the covers in response to manual actuation. In the illustrative embodiment, each compartment 14, 15 is individually closable and latchable utilizing its own catch-release lock 22. A pushbutton 24 is operatively linked to the lock mechanism for each cover such that manual actuation of the pushbutton 24 simultaneously releases the catches for all compartment covers 16, 17. Essentially, all the catches for each compartment 14, 15 are interconnected to a mechanical linkage assembly. A vertically depressable (shown in FIG. 2) or a laterally slidable (shown in FIG. 3) pushbutton 24 engages a chain, and a press or a slide of the button shifts the chain. Each catch includes an eye that receives an associated hook on the chain. The shifting on the chain pulls on the hooks, which further pull on the catches to release the locks. The compartment covers 16, 17 essentially open in unison when they are manually released, but they can be opened in sequence when they are automatically released. While the manual actuator for the catches shown in FIGS. 2 and 3 is the pushbutton 24 on the dispenser body 12, this actuator is not limited to depressible button 24; rather, it may take a form of switches that the operator flips or knobs that the operator turns, or any other suitable manually actuable devices. The pushbutton 24 is in direct mechanical relationship with all catches so that all covers 16, 17 release together.

The covers 16, 17 may be powered, for example, by a helical torsion spring 26. The hinges 18 are essentially coiled springs 26 that naturally maintain the compartment covers 16, 17 in an open position. The catch-lock mechanism overcomes a force of the springs 26 to maintain the compartment covers 16, 17 closed over the compartments 14, 15. During these closed periods, the spring stores energy. Once the catches release the respective locks, the torsion spring 26 immediately forces the compartment covers 16, 17 to swing open so that the springs can return to their natural rest-state.

An advantage in this disclosure is that an operator can utilize multiple detergent types in one wash cycle. Some detergents are enzyme based; they are typically most effective against food soils. Other detergents are chlorine based; they are typically most effective on stains. Chlorine-based detergents cannot be mixed with enzyme-based ones because chlorine in the former destroys enzymes in the latter; hence, existing dispensers prevent operators from utilizing a combination of detergent types during wash cycles. The present multi-compartment dispenser 10 provides users with an opportunity to combat both food soils and stains by separately containing both chlorine-based and enzyme-based detergents in the dispenser body 12. It is anticipated that chlorine-based detergent can be poured into one of the compartments 14, 15 while enzyme-based detergent is poured into another. Since the individual covers 16, 17 do not need to be closed in unison, an operator can first pour the enzyme-based detergent in select compartments 14, 15 and manually close those compartment covers 16, 17 to prevent any chlorine from deactivating the granules. The operator can then pour the chlorine-based detergent into to the neighboring, remaining compartments 14, 15. The compartments 14, 15 are commanded to release the detergents at the same or different stages of the wash cycle.

FIG. 3 shows the compartment covers 16, 17 completely closed over the compartments 14, 15 to protectively house the contents therein. The covers 16, 17 prevent moisture from compromising the detergents contained in the compartments 14, 15. No water contacts detergent until the respective compartment cover 16, 17 is automatically released. The present dispenser module 10 facilitates better wash processes for dishwashers by enabling each of the compartment covers 16, 17 to open separately in the wash cycle in a time sequence that is controlled by means of an actuator (not shown).

The actuator activates the cover's 16, 17 release at a proper time and sequence, which is dependent upon the output of a controller. The controller is arranged to optimize wash performance based on a combination of inputs and the nature of the controller. The controller may range in complexity from a basic mechanical paraffin wax actuator to an electromechanical timer based actuator, to a microprocessor based electronic controller. Thus, there are several methods in which the present compartment covers 16, 17 can be commanded open. A first method utilizes a paraffin wax actuator (not shown). The paraffin actuator exercises throughout the wash cycle; it actuates a ratcheting disc (not shown) or stem which automatically opens the compartments 14, 15 in sequence each time the paraffin actuator responds to particular changes, such as, temperature changes, in the chamber environment. The paraffin wax actuator responds to phase changes in the wax, which is dependent on the chamber's temperature. For example, the wax actuator can actuate release of a cover 16, 17 either when hot water enters the wash chamber at a beginning of a wash stage, thus melting the wax, or when hot water drains from the chamber at an end of a wash stage, thus solidifying the wax.

Oftentimes, the most effective wash process is achieved by proper timing of a detergent release. For certain soils, it may be more appropriate to dispense detergent simultaneously with a spraying of the wash fluid jets so that the water immediately carries the detergent to the dish. In that case, the paraffin wax actuator controls the timing of the release of the detergent during a particular wash cycle. The high temperature of the wash fluid causes a rise in the wash chamber environment, thus melting the wax in the paraffin actuator. When this wax melts, the actuator forces a release of the appropriate compartment cover 16, 17. For other soils, it may be more appropriate to dispense the detergent in the chamber between wash periods, such as, for example, after completion of one wash cycle and before a start of a next wash cycle. In that case, the paraffin wax actuator triggers release of the detergent when the temperature drops in the chamber environment. The chamber environment cools as the hot wash fluid drains. This drop in temperature solidifies the wax in the paraffin actuator; hence, the actuator forces a release of the appropriate compartment 16, 17 when no wash fluid is circulating the chamber.

A second method utilizes an electromechanical timer that activates a controller, which executes release commands each instance the timer goes off. One timer may be used for all compartment covers 16, 17, in which case the timer is set to a constant cycle and it reactivates for a preset time after it goes off. Separate timers can be used for each compartment cover 16, 17 as well. Each of the separate timers is in direct communicative relationship to a central circuit that commands release of the various compartment covers 16, 17. Additionally, a thermostatic device can be integrated into the circuit such that the detergent dispensing lid only activates when a certain temperature set point is achieved. Furthermore, two or more thermostatic devices can be used to trip each detergent cover 16, 17 separately, in which case each detergent dispensing lid has a unique temperature set point.

A third method utilizes a microprocessor-based electronic controller to activate a release of compartment covers 16, 17 when certain parameters are met. In this case, the controller can be pre-programmed to trip each detergent lid at a fixed time within the cycle or to respond to sensor inputs, such as, for example, when wash fluid empties after it circulates in the wash chamber, and when wash fluid reaches a certain temperature, etc. For instance, there are specific amounts of detergent and specific times of detergent dispenses that achieve optimum wash and spotting performance for different temperatures. The same is true for certain turbidity levels or for high and low soil concentrations. A sensor inside the dishwasher for measuring water turbidity and soil levels can activate a release of covers 16, 17 when readings meet a certain minimum. Another sensor can be placed inside the compartments 14, 15 to determine whether the detergent type poured therein is a gel or a powder, and whether that detergent is a chlorine-based or an enzyme-based one. An optimal wash performance is based on specific ratios of the detergent type. Timing and release of the ideal concentrations are computed using any of a number of various sensor readings. When using sensors with the microprocessor controller, the sensor is tied to the controller via electrical conductors, i.e. wires. The controller can continuously or periodically monitor the sensor readings and act accordingly. For example, during a main wash it might be desirable to add the detergent only when the wash fluid is between 130° F. and 135° F. During the main wash the controller can monitor the wash fluid temperature and turn a heating element on or off as necessary to achieve the desired set point. When the temperature set point is achieved, the dishwasher controller can send an electrical signal via electrical conductors (wires) to the paraffin wax actuator to activate it releasing the appropriate detergent lid. When the resistive element has a voltage placed across it, the element heats up causing a change of state in the paraffin wax. As the wax expands, the piston is pushed partially out of the cylinder. The system is designed such that the piston performs a mechanical operation (release a latch, engage a switch, move a lever, etc.). When the voltage is removed from the resistive element, the device cools allowing the wax to contract and pull the piston back into the cylinder. As an additional example, the controller can continuously or periodically monitor a turbidity sensor input. Under light soil loads, the controller can be programmed to only activate one of the detergent dispensing lids conserving detergent for the next cycle. Under heavy soil loads, the controller can be programmed to release all of the detergent. When all of the detergent is used it can be released all at once or in stages.

A sensor is tied to the foregoing microprocessor controller by means of electrical conductors. The controller continuously or periodically monitors the sensor readings to act accordingly. For example, it can be desirable to add detergent to a main wash cycle only when wash fluid is between 130° F. and 135° F. During the main wash, the controller monitors the fluid temperature and turns the heating element on or off as necessary to achieve the desired set point. When the temperature set point is achieved, the controller can send a signal (via wires) to the paraffin wax actuator to activate its release of the appropriate detergent lid. As an additional example, the controller can continuously or periodically monitor a turbidity sensor input. Under light soil loads, the controller can be programmed to only activate one of the detergent dispensing lids, thus conserving detergent for the next cycle. Under heavy soil loads, the controller can be programmed to release all detergents, either simultaneously or in stages.

When an electromechanical timer controller or a microprocessor-based electronic controller is used, an electrically actuated solenoid can be used in place of the paraffin wax actuator. In this case, either control type could utilize a predetermined fixed time interval for the multiple detergent doses or to dispense the detergent based on sensor inputs. The sensor inputs can be based on a thermostatic device, a temperature sensor, a soil sensor, etc. An electromechanical timer would likely be limited to using a temperature sensor. When the timer reached a certain point in the cycle, the circuit could be designed to wait until a thermostatic control is actuated, completing the circuit to allow the timer to trip the detergent dispenser and continue washing for a fixed time. Multiple thermostatic devices could be used to trip each detergent lid separately.

A combination of the foregoing methods can be similarly utilized. For example, a paraffin actuator can be used to sequentially release covers 16, 17 on a series of compartments 14, 15 dedicated to different wash cycles, but a timer can be used to release covers on compartments dedicated to release stages within any one cycle. More specifically, a paraffin actuator can release the covers 16, 17 to respective compartments 14, 15 at a beginning of a pre-wash, a main wash, and a rinse cycle. A timer can then activate a release of a different compartment cover 16, 17 after a set number of minutes into the main wash cycle.

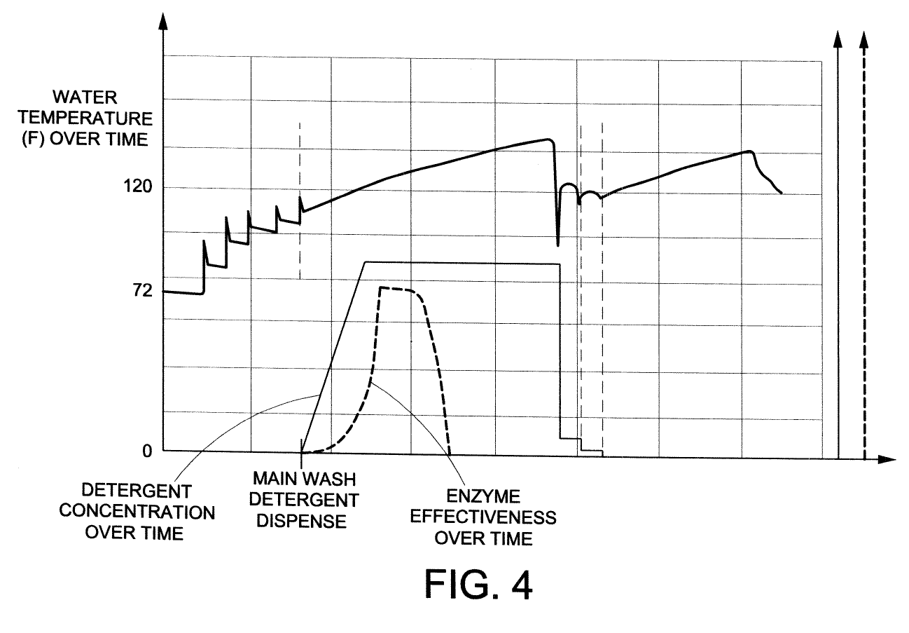

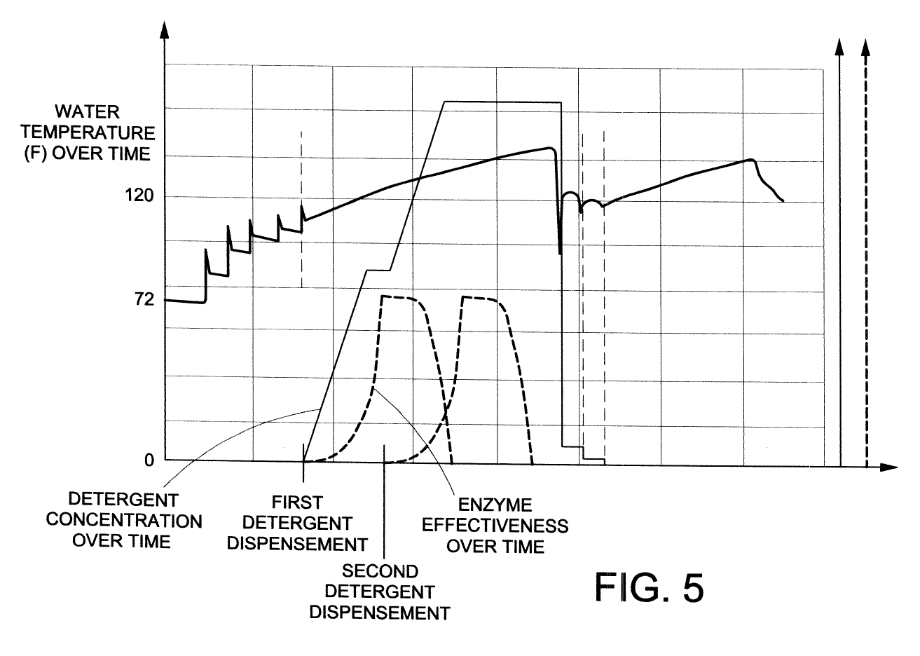

There is no limitation placed on the method or the actuator utilized to release compartment covers 16, 17. Both mechanical and electrically activated systems provide the advantages made available by a multi-compartment dispenser 10. The contents of FIGS. 4 and 5, when compared to each other, predict advantages of detergent dispensed during multiple phases of a wash cycle. FIG. 4 is a graph recording the effectiveness of powder detergents over a typical wash cycle that utilizes existing systems. FIG. 5 is a graph recording the effectiveness of powder detergents over a typical wash cycle utilizing the dispenser module presently disclosed. There are two distinct advantages to the present system: (1) the enzyme remains active for a greater duration of the wash cycle; and, (2) the dishes are exposed to a higher concentration of detergent for a longer duration. The enzymes remain activated for at least twice the time period known for conventional dispensers. The longer activation period is represented in FIG. 5 as doubling over time because of the two detergent releases (shown in dotted lines). The longer exposure to higher detergent concentration is represented in FIG. 5 as nearly doubling over that of a same period in normal operating cycles. The higher concentration is more specifically represented as a second spike (shown in solid line) in the graph when the second detergent is dispensed. The present detergent dispenser 10 permits detergent to be dispensed little at a time, instead of the entire concentration being forced as a single release in one cycle segment.

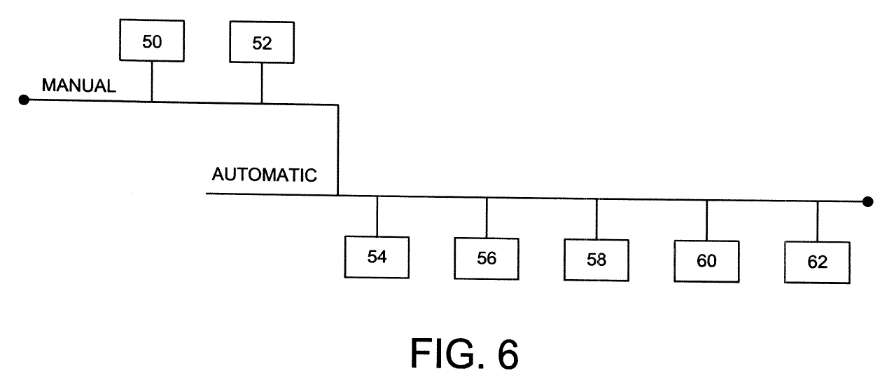

FIG. 6 is a schematic mapping of one of many possible methods of utilizing the present dispenser module in a wash cycle. The schematic diagram utilizes a dispenser module having at least four compartments: a first that releases detergent for a pre-wash cycle; a second that releases detergent at a start of the main wash cycle; a third that releases detergent in the middle of the main wash cycle; and, a fourth that releases bleach during a first rinse cycle. The method includes a first step 50 of manually opening covers to all compartments on the dispenser body. The operator presses the push-button to release the catch for all cover locks. The second step 52 requires the operator to fill at least one of the four compartments with a selected detergent. The operator can use any “automatic” detergent that is dishwasher compatible: liquid, gel, powder, and tablet. The operator must fill at least one of the designated main wash compartments to thoroughly clean dishes. A filling of the pre-wash, second main wash and rinse compartments is optional.

If the operator selects to utilize multiple detergent types to combat different grime and stain problems, then he or she will close the cover(s) corresponding to the first filled compartments. The operator then fills the remaining compartments with the next selected detergent. A particular advantage to the dispenser body 12 is that all compartments are adjacent, so the operator can always pour any detergent in one sweeping hand gesture. The covers on closed compartments prevent mixture of multiple detergent types.

The present disclosure does not require that an operator utilize two detergent types or all compartments during every wash cycle. Once all the detergents are manually poured into compartments and the corresponding covers are manually closed over them, the operator closes the chamber door and enters his or her desired wash cycle selections utilizing a control selector. The user can further enter any of a plurality of value inputs into the control selector to optimize wash performance, for example, user-measured water hardness in the house, and desired wash fluid temperature; etc. It is not necessary that the user enter which detergent type he or she poured into each compartment. A conductivity sensor may be included inside each compartment to recognize varied detergent types.

Throughout the dishwasher cycle, the dishwasher calculates the right amount of each detergent type to dispense at the most efficient times and in the most efficient sequence. These calculations are based on both the user's inputs and the sensors' readings. Any of the foregoing methods can be utilized to activate each compartment cover's release. Step 54 of the example embodiment shows an optional first pre-wash cycle that mainly wets dishes. The wash fluid falls to the floor where it is collected in the pump system for circulation before step 56, wherein the first compartment releases detergent therein during a second pre-wash cycle. Dishwasher sensors measure water temperature and soil/turbidity levels before the main wash. The second compartment cover is timed to release at an initiation of the main wash (step 58) so that the detergent therein can dispense with the washing fluid entering the chamber through the spray arm conduits. This detergent concentration dilutes and becomes less effective over time, so step 60 reintroduces additional detergent after a preset time has passed in the main wash. After the wash fluid utilized in the main wash empties, step 62 activates an introduction of contents in the final compartment before a first rinse. The content(s) can be bleach, which is used to sanitize dishes. The final step includes a final rinse with just water so that all remaining detergent is removed from the chamber. An optional, timed drying session can be included.

The present dispenser module is not limited to the embodiment shown in FIG. 1; rather, a variable dispensing method can be achieved with many different detergent dispenser structural designs. The body 12 can have any of a plurality of sizes and shapes, for example, one set within the chamber door's 140 width, one that protrudes outwards from the door's interior surface, and one that is round-shaped with radial-extending compartments, etc. The compartments 14, 15 can similarly comprise any of a number of dimensions. The most preferred embodiment comprises compartments that vary in size. FIG. 2 shows the second compartment 15 that is at least two times larger than the first compartment 14. The largest compartment 14, 15 can be dedicated to the main wash cycle.

Detergent dispensers can further employ multiple, color-coded compartments and covers. For example, one compartment or cover can be color-coded to indicate proper containment of chlorine or enzyme based detergent types for certain combination detergent cycles. The user has an option to fill each different detergent type into a properly assigned color coded compartment.

It is finally anticipated that this dispenser module 10 can be adapted to all existing dishwasher models. Dishwashers that comprise double drawers, for example, offer operators different cycle options and convenience features. It is anticipated that a double drawer dishwasher utilizes one dispenser module 10 per drawer, or further embodiments can be comprised as a centralized dispenser that automatically defaults to a primary drawer for single-chamber washes.

The disclosure describes with reference to the preferred embodiments. Obviously, modifications and alterations will occur to others upon reading and understanding the preceding detailed description. It is intended that the disclosure be construed to include such modifications and alterations.

What is claimed is:

1. A dishwasher detergent module used for dispensing detergent, comprising:
a dispenser body having at least two individual, isolated compartments that prevent intermix of contents;
corresponding latch covers that close over each of said compartments;
whereby detergent may be released from each of said compartments during a different stage of a wash cycle.

2. The dishwasher detergent module of claim 1, further comprising:
walls that extends above a height of opposing sidewalls of said compartments to further partition each said compartment from an adjacent said compartment; and,
hinges that extend a length between distal ends of said walls;
wherein said covers remain affixed to said dispenser body by means of said hinges.

3. The dishwasher detergent module of claim 2, further comprising:
a manually actuable catch-release lock for each of said compartments, said covers close and release by means of said catch-lock;
wherein said catch-release lock is operative to simultaneously release said catches for all said covers such that said covers open in unison when they are manually released, but they open in sequence when they are automatically released.

4. The dishwasher detergent module of claim 1,
further comprising a cover actuator to cause said covers to open separately during the wash cycle in a time sequence, said actuator is selected from a group comprising:
a paraffin wax or solenoid actuator that automatically opens said compartments in sequence each time said paraffin actuator responds to changes in a chamber environment;
a timer activated controller which activates said covers to release at predetermined times;
sensors that activate said covers to release when certain parameters are met; and,
a combination of said wax or solenoid actuators, said timer, and said sensors.

5. The dishwasher detergent module of claim 1, wherein each of said compartments is assigned to a stage of the wash cycle, the wash cycle comprising one or more particular cycles selected from a group comprising a first pre-wash cycle, a second pre-wash cycle, a main wash cycle, a first rinse cycle and a second rinse cycle, wherein said particular cycles may comprise multiple stages.

6. The dishwasher detergent module of claim 1, wherein each of said compartments can contain a different detergent type from a next compartment, the detergent types are selected from a group comprising: liquid detergents, gel detergents, powder detergents, granule detergents, and bleach;
and wherein said compartments can be commanded to release the different detergents types at a same or at the different stages of the wash cycle.

7. The dishwasher detergent module of claim 1, wherein each of said compartments vary in size such that different volumes of detergent are dispensed in the different stages of the wash cycle.

8. A method to wash dishes utilizing a multiple-compartment detergent dispenser that having a plurality of compartments and corresponding covers that are set to release in sequence, said method comprises at least two automatic steps selected from a group comprising:
time-releasing a cover on a first compartment during a pre-wash cycle that mainly wets dishes;
time-releasing a cover on a second compartment at an initiation of a main wash cycle;
time-releasing a cover on a third compartment to reintroduce additional detergent after a preset time has passed in the main wash cycle;
time-releasing a cover on a fourth compartment to reintroduce a sanitizing agent at an initiation of a rinse cycle.
